(19) United States
(12) Patent Application Publication
(10) Pub. No.: US 2020/0290132 A1
(43) Pub. Date: Sep. 17, 2020

(54) Apparatus and Methods for Improved Hole Saw Drilling

(71) Applicants: Thomas J. Fenoglio, New Lenox, IL (US); Joseph J. Fenoglio, Captiva, FL (US)

(72) Inventors: Thomas J. Fenoglio, New Lenox, IL (US); Joseph J. Fenoglio, Captiva, FL (US)

(21) Appl. No.: 16/815,715

(22) Filed: Mar. 11, 2020

Related U.S. Application Data
(60) Provisional application No. 62/816,640, filed on Mar. 11, 2019.

(51) Int. Cl. B23B 51/04; B23B 35/00

(52) U.S. Cl. CPC B23B 51/0426; B23B 35/00

(57) ABSTRACT

The present disclosure is directed to a novel hole saw assembly for use with a removable guide or pilot drill bit in which either or both of a cutting device on the hole saw and/or the tip of the removable pilot drill comprise a hard material, such as diamond or tungsten carbide, or another hard material. The novel hole saw assembly is configured to improve the function of keeping the cutting edge of the cutting device properly located during the hole saw cutting or drilling process, especially when cutting or drilling a hole in materials with surfaces that are hard or slippery, such as stone, glass, certain metals or porcelain, or ceramic floor, ceiling or wall tile.

### CROSS-REFERENCE TO RELATED APPLICATION

This application claims priority to U.S. provisional application No. 62/816,640, filed Mar. 11, 2019, entitled APPARATUS AND METHODS FOR IMPROVED HOLE SAW DRILLING, which is hereby incorporated by reference in its entirety as though fully set forth herein.

### FIELD OF THE DISCLOSURE

The present disclosure relates to a novel hole saw, and in particular, the present disclosure relates to a novel hole saw for use with a removable guide or pilot drill bit in which either or both of the blade of the hole saw, and the tip of the removable pilot drill bit, comprise a hard material, such as diamond or tungsten carbide, on the cutting edge of the hole saw or the cutting tip of the pilot drill bit. The novel hole saw and removable drill bit is configured to improve the function of keeping the hole saw in the proper location during the hole saw cutting or drilling process, especially when cutting a hole in surfaces that are hard or slippery, such as stone, certain metal, glass or porcelain or ceramic floor, ceiling or wall tile.

In use, the present disclosure relates to a novel hole saw incorporating a removable pilot drill bit in which one or both of the hole saw and drill bit comprise a hard material that will cut into almost any material to be drilled. The configuration of the pilot drill bit, which extends past the edge of the hole saw, allows for the drill bit to make contact with the material to be cut or drilled first. Once the drill bit contact is made, the hole saw will follow and the entire novel hole saw will stay in the correct location while the material is cut or drilled. The hard material on the drill bit will assist in keeping the drill bit from sliding on the material to be cut or drilled, while the hard material on the edge of the hole saw will assist in keeping the hole saw in its proper location and orientation during the cutting or drilling procedure.

### BACKGROUND OF THE INVENTION

A drill bit is useful for creating a hole in a piece of material such as wood, metal or ceramic tile. When the need for that hole has a circumference larger than the diameter of the drill bit, one way to accomplish the task is to use a hole saw. A hale saw contains a circular or annular cup-shaped saw device that contains multiple teeth used in the hole cutting process. The hole saw also contains a shank at the end opposite the cutting teeth. The shank is configured to be inserted into and securely held by the chuck of an electric or cordless drill.

Usually, the hole saw also contains an indent centered on the hole saw axis, which can hold the shank of a pilot bit, that when inserted into the hole saw indent, has a tip that projects beyond the hole saw rim. Once the pilot bit is inserted into the hole saw and the hole saw shank is inserted into the drill chuck, the hole saw can be used to cut a hole in the material.

When the cutting process begins, the pilot bit, which extends past the cutting edge of the cutting device, makes initial contact with the surface of the material in the center of the hole to be cut. The pilot bit will enter the surface of the material in the center of the hole to be cut, for a short time before the hole saw cutting edge makes contact with the surface of the material. This step will keep the hole saw properly aligned during the beginning of the hole cutting. Once the teeth on the cutting edge of the hole saw contact the material, the circular cutting begins with the hole being cut around the center point created by the pilot bit. As the process continues, the cutting edge of the hole is driven through the Material until the hole saw finishes cutting the hole in the material.

The hole saw provides the hole cutting functionality using the pilot bit to reduce the hole saw from slipping or walking during the hole cutting process. However, in certain instances, the pilot drill bit and the cutting portion of the hole saw tend to slip or walk from the intended cutting target, before or during the cutting process. By slipping or walking from the intended target, at a minimum, the material being cut may be destroyed and need to be replaced, or in certain situations the hole saw and/or the drill may be damaged and the user can be injured.

The disadvantages are particularly troublesome when the material is harder than wood, for example certain metals, stone glass or porcelain or ceramic floor, ceiling or wall tile. In these situations it would be advantageous for the hole saw and/or the pilot drill bit to be configured to more easily cut into the hard material, such as stone, certain metals, glass or porcelain or ceramic floor, ceiling or wall tile. The present disclosure satisfies these needs.

### SUMMARY OF THE DISCLOSURE

In general and in order to solve the above-mentioned shortcomings in the existing hole saw design and the hole saw drilling process, the present disclosure utilizes an apparatus and methods that incorporate a novel and improved hole saw with a removable pilot drill bit in which either or both of the hole saw cutting blade and the tip of the pilot drill bit comprise a material that is hard enough to cut any material without the hole slaw slipping or walking from the intended target during the cutting process. The hole saw cutting blade and/or the tip of the pilot drill bit may comprise a hard material, such as diamond or tungsten carbide, on the cutting edges or the cutting tip, for minimizing slippage or walking during the hole saw drilling process, although other hard materials will suffice.

It is therefore an object of the present invention to provide an apparatus that incorporates a novel and improved hole saw with a cutting edge that comprises a hard material such as diamond or tungsten carbide that is hard enough to cut any material without the hole slaw slipping, sliding or walking from the intended target during the cutting process.

Another object of the present invention to provide an apparatus that incorporates a novel and improved hole saw and a pilot drill bit, in which either or both of the hole saw cutting blade and the tip of the pilot drill bit comprises a hard material such as diamond or tungsten carbide or other hard materials that are hard enough to cut almost any material without the hole slaw slipping, sliding or walking from the intended target during the cutting process.

A further object of the present invention to provide an apparatus that incorporates a novel and improved hole saw and a removable pilot drill bit, in which either or both of the hole saw cutting blade and the tip of the pilot drill bit comprises a hard material such as diamond or tungsten carbide or other hard materials that are hard enough to cut any material without the hole slaw slipping, sliding or walking from the intended target during the cutting process.

A further object of the present invention to provide an apparatus that incorporates a novel and improved hole saw and a removable pilot drill bit, such that in use, the pilot drill bit of the novel hole saw, which extends past the edge of the hole saw, makes contact with the material to be cut or drilled first, in the center of the hole saw wall. Once the drill bit makes contact, the hole saw will follow and the entire novel hole saw will stay in the correct location and configuration while the material is cut or drilled. The hard material on the drill bit will assist in keeping the drill bit from sliding or slipping on the material to be cut or drilled, while the hard material on the edge of the hole saw will assist in keeping the hole saw in its proper location and orientation during the cutting or drilling procedure.

Additional objectives and advantages of the present disclosure will become apparent to one having ordinary skill in the art after reading the specification in light of the drawing figures, however, the spirit and scope of the present invention, including the appended claims, should not be limited to the description of the embodiments contained herein.

### DETAILED DESCRIPTION OF THE DRAWINGS

The preferred embodiments of the disclosure will be described in conjunction with the appended drawings provided to illustrate and not to the limit the disclosure, where like designations denote like elements, and in which:

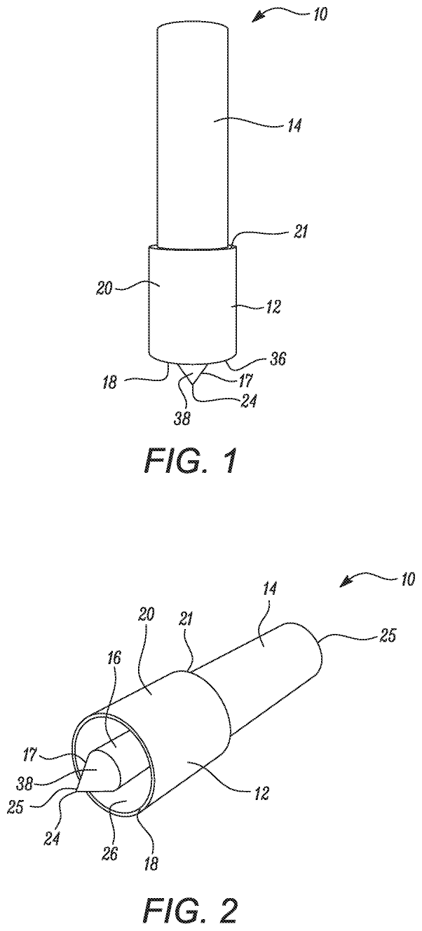

FIG. 1 illustrates a front view of an improved hole saw and pilot drill bit in accordance with one embodiment of the present disclosure;

FIG. 2 illustrates a perspective view of an improved hole saw and pilot drill bit in accordance with one embodiment of the present disclosure;

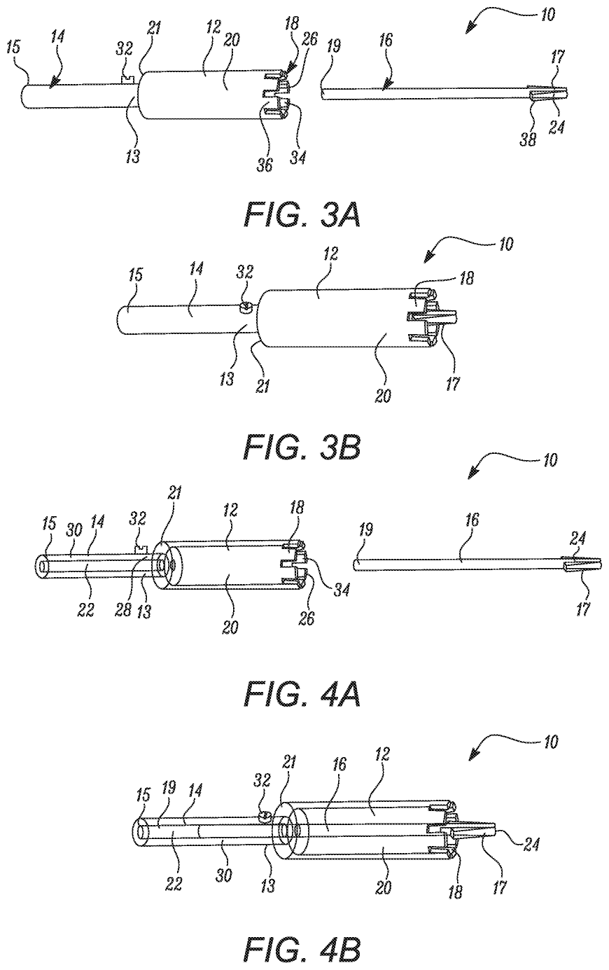

FIGS. 3A and 3B illustrate exploded and assembled perspective views of an improved hole saw and pilot drill bit in accordance with one embodiment of the present disclosure; and

FIGS. 4A and 4B illustrate exploded and cutaway views of an improved hole saw and pilot drill bit in accordance with one embodiment of the present disclosure.

### DETAILED DESCRIPTION OF THE PRESENT INVENTION

Referring to the drawings, wherein like reference numerals refer to the same or similar features in the various views, the present disclosure pertains to a novel hole saw assembly 10, that is made up of multiple elements, but could also be an integrated piece containing all of the elements. The hole saw assembly 10 is intended to be inserted into and securely held by the chuck of an electric or cordless drill.

FIGS. 1 through 4 show the front view, perspective view, disassembled and cutaway views of an improved hole saw assembly 10, respectively, comprising generally a cutting device 12, an attachment shank 14, and a removable pilot drill or guide drill bit 16. Although the preferred embodiment discloses these elements as separate objects, the scope of the present disclosure also encompasses an integrated device in which all of the objects and functionality are combined into a single device.

The cutting device 12 comprises a cutting edge 18 at the open end 19 of the cutting device 12 and a cylindrically cup-shaped wall 20, attached to the first end 13 of the shank 14, at the other end 21 of the cutting device 12. The shank 14 has a partial or completely hollow portion 22, as shown in FIG. 4, which is accessible from the open end 26 of the cylindrical cup-shaped wall 20. The shank 14 is configured to be inserted into a drill chuck (not shown) at the end 15 opposite the cutting device 12, and to be tightly and securely held in place by the drill chuck on the drill.

Further, the pilot drill 16 comprises a cutting tip 24 at one end 17, and is configured at the opposite end 19 of the pilot drill 16, to be inserted into the hollow portion 22 of the shank 14, near the first end 13, such that the pilot drill will be centered on an axis 25 created by the center of both the cutting device 12 and the shank 14. Once inserted into the hollow portion 22 of the shank 14, the cutting tip 24 of the pilot drill 16 will extend past the end 26 of the cutting device 12.

The shank 14 comprises a threaded hole 28, as shown in FIG. 4A, in the side 30 of the shank 14, making it capable of receiving a setscrew 32, as shown in FIGS. 3A, 3B, 4A and 4B, to hold the pilot drill 16 in place inside the hollow portion 22 of the shank 14, during the cutting or drilling process. The cutting edge 18 can be made up of multiple teeth 34 and the teeth 34 comprise a hard material 36, such as diamond or carbide made up of or integrated into, the teeth 34 of the cutting edge 18.

This hard material 36 allows the cutting edge 18 of the cutting device 12, to cut through almost all difficult to cut materials, such as porcelain or ceramic floor, ceiling or wall tile, or certain metals, glass and stone. By using the hole saw assembly 10, the cutting or drilling process can be accomplished without the pilot drill 16 or cutting device 12 of the hole saw 10 sliding, slipping or walking from the intended target.

Additionally, the end 17 of the cutting tip 24 of the pilot drill 16 also contains a hard cutting tip material 38, such as diamond, tungsten carbide or a similar hard material. Once the opposite end 19 of the pilot bit 16 is inserted into the end 13 of the shank 14, and the cutting tip 24 of the pilot bit 16 extends beyond the cutting edge 18 of the cutting device 12, the hole saw assembly 10 can be used to cut a hole in the difficult to cut material, such as certain metals, stone, glass or porcelain or ceramic floor, ceiling or wall tiles.

When the cutting process begins, the cutting tip 24 with the hard cutting tip material 38, which extends past the cutting edge 18, makes initial contact with the material to be cut or drilled, at the intended target location, in the center of the hole to be cut. The cutting tip 24 of the pilot bit 16 will enter the surface of the material (not shown) for a short time before the cutting edge 12 containing the hard material 36 on the multiple teeth 34 makes contact with the material to be cut or drilled.

Due to the hard cutting tip material 38, the cutting tip 24 of the pilot bit 16 will not slip, slide or walk from the intended target. Thus, the cutting edge 18 of the cutting device 12 will be properly located and aligned during the beginning of the actual hole cutting process.

Once the teeth 34 on the cutting edge 18 of the hole saw assembly 10 contact the surface of the difficult to cut material, the circular cutting begins with a hole being drilled or cut out around the center point created by the cutting tip 24 of the pilot bit 16. As the process continues, the cutting edge 18 cuts through the material until the hole saw assembly finishes cutting the hole in the material.

The hole saw assembly 10 described herein provides the hole cutting or drilling functionality using the cutting tip 24 of the pilot bit 16 to mitigate the hole saw assembly 10 from slipping or walking during the hole cutting or drilling process. To the extent that the cutting tip 24 of the pilot drill 16 wears down over time, or a different type of cutting tip 24 is preferred or needed, the pilot drill 16 can be removed from the shank 14 by loosening or removing the setscrew 32, removing and replacing the pilot drill 16 (with another pilot drill) and replacing or tightening the setscrew 32.

While the invention has been illustrated and described as embodied in a hole saw assembly 10, it is not intended to be limited to the details or the preferred embodiment disclosed and shown, since various modifications and structural changes may be made without departing in any way from the spirit of the present disclosure.

It will be understood that the embodiments of the present disclosure, which have been described are illustrative of some of the applications of the principles of the present disclosure. Although numerous embodiments of this disclosure have been described above with a certain degree of particularity, those skilled in the art could make numerous alterations to the disclosed embodiments without departing from the spirit or scope of this disclosure.

All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the disclosed system and methods.

Additionally, joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the disclosed apparatus, system and methods as disclosed herein.

1. An improved hole saw assembly for drilling or cutting a hole in a surface of a hard material without slipping, sliding, or walking from an intended target on the surface of the material, comprising:
a cutting device, said cutting device comprising a first device end and a second device end, with a cylindrically cup-shaped wall with an opening at said first device end of the cup-shaped wall, a cutting edge at said first device end of the cup-shaped wall, said cutting edge comprising multiple teeth, said multiple teeth comprising a hard device material;
an attachment shank, said attachment shank comprising a first shank end and a second shank end, with a hollow portion, said hollow portion being accessible through the opening of the cylindrical cup-shaped wall; and
a removable pilot drill, said removable pilot drill comprising a first drill end and a second drill end, with a cutting tip at the first drill end, said removable pilot drill comprising a hard tip material, said removable pilot drill configured to be inserted at said second drill end into the hollow portion of said attachment shaft at said second shank end along an axis, such that when inserted into said hollow portion of said attachment shaft, the cutting tip of the removable pilot drill extends past the first device end of the cutting device;
wherein said cutting device and pilot drill are configured to drill or cut a circular hole in the surface of the hard material without slipping, sliding, or walking from the intended target on the surface of the material.

2. The improved hole saw assembly for drilling or cutting a hole in a surface of a hard material in claim 1, wherein said hard device material comprises diamond.

3. The improved hole saw assembly for drilling or cutting a hole in a surface of a hard material in claim 1, wherein said hard device material comprises tungsten carbide.

4. The improved hole saw assembly for drilling or cutting a hole in a surface of a hard material in claim 1, wherein said hard tip material comprises diamond.

5. The improved hole saw assembly for drilling or cutting a hole in a surface of a hard material in claim 1, wherein said hard tip material comprises tungsten carbide.

6. The improved hole saw assembly for drilling or cutting a hole in a surface of a hard material m 1, wherein said hollow portion is completely hollow.

7. The improved hole saw assembly for drilling or cutting a hole in a surface of a hard material in claim 1, wherein said hollow portion is partially hollow.

8. The improved hole saw assembly for drilling or cutting a hole in a surface of a hard material in claim 1, further comprising a setscrew, such that when said removable pilot drill is inserted into said hollow portion of said attachment shaft, said setscrew is used to hold said removable pilot drill in place.

9. The improved hole saw assembly for drilling or cutting a hole in a surface of a hard material in claim 1, further comprising a drill chuck, wherein said attachment shank is configured to be inserted at the first shank end into a drill chuck, said attachment shank further configured to be tightly and securely held in place by the drill chuck.

10. A method of drilling or cutting into a surface of a hard material without slipping, sliding, or walking from an intended target, using an improved hole saw assembly comprising a cutting device, said cutting device comprising a first device end and a second device end, with a cylindrically cup-shaped wall with an opening at said first device end, a cutting edge at said first device end, said cutting edge comprising multiple teeth, said multiple teeth comprising a hard device material, an attachment shank, said attachment shank comprising a first shank end and a second shank end, with a hollow portion, said hollow portion being accessible through the opening of the cylindrical cup-shaped wall, and a removable pilot drill, said removable pilot drill comprising a first drill end and a second drill end, with a cutting tip at the first drill end, said removable pilot drill comprising a hard tip material, said removable pilot drill configured to be inserted at said second drill end into the hollow portion of said attachment shaft at said second shank end along an axis, such that when inserted into said hollow portion of said attachment shaft, the cutting tip of the removable pilot drill extends past the first device end of the cutting device, the steps comprising:
a) inserting said first shank end of said attachment shank into a drill chuck on a drill;
b) tightening said drill chuck;
c) locating said removable pilot drill through said opening of the cylindrical cup-shaped wall into said hollow portion at said second shank end;
d) tightening a setscrew to securely hold said pilot drill in place;
e) placing the cutting tip at the first drill end at the intended target and drilling into the surface of the hard material without slipping, sliding, or walking from the intended target, wherein the pilot drill will make contact with the surface of the hard material before the cutting device will make contact with the surface of the hard material, and then the cutting device will drill or cut a circular hole in the surface of the hard material without slipping, sliding, or walking from the intended target.

11. The method of drilling or cutting into a surface of a hard material without slipping, sliding, or walking from an intended target in claim 10, wherein said hard device material comprises diamond.

12. The method of drilling or cutting into a surface of a hard material without slipping, sliding, or walking from an intended target in claim 10, wherein said hard device material comprises tungsten carbide.

13. The method of drilling or cutting into a surface of a hard material without slipping, sliding, or walking from an intended target in claim 10, wherein said hard tip material comprises diamond.

14. The method of drilling or cutting into a surface of a hard material without slipping, sliding, or walking from an intended target in claim 10, wherein said hard tip material comprises tungsten carbide.

15. The method of drilling or cutting into a surface of a hard material without slipping, sliding, or walking from an intended target in claim 10, wherein said hollow portion is completely hollow.

16. The method of drilling or cutting into a surface of a hard material without slipping, sliding, or walking from an intended target in claim 10, wherein said hollow portion is partially hollow.

17. The method of drilling or cutting into a surface of a hard material without slipping, sliding, or walking from an intended target in claim 10, further comprising a setscrew, such that when said removable pilot drill is inserted into said hollow portion of said attachment shaft, said setscrew is used to hold said removable pilot drill in place.

18. The method of drilling or cutting into a surface of a hard material without slipping, sliding, or walking from an intended target in claim 10, further comprising a drill chuck, wherein said attachment shank is configured to be inserted at the first shank end into a drill chuck, said attachment shank further configured to be tightly and securely held in place by the drill chuck.
